(19) United States
(12) Patent Application Publication
(10) Pub. No.: US 2002/0058517 A1
(43) Pub. Date: May 16, 2002

(54) Informing system

(76) Inventors: Toshihiko Furukawa, Hiroshima (JP); Kiyoshi Ishimi, Hiroshima (JP); Mitsuru Ohba, Hiroshima (JP)

Correspondence Address: MOONRAY KOJIMA, BOX 627, WILLIAMSTOWN, MA, 01267, US

(21) Appl. No.: 09/739,195

(22) Filed: Dec. 18, 2000

(30) Foreign Application Priority Data
Nov. 13, 2000 (JP) 00/345,138

(51) Int. Cl. H04Q 7/20

(52) U.S. Cl. 455/456; 455/404; 455/521

(57) ABSTRACT

The present invention relates to an informing system capable of informing the service institution or the public institutions like police, fire extinguishing service, safety and welfare or hospitals of the current location of the person possessing the terminal device and also informing movable bodies like taxies thereof, wherein it is possible to detect precisely the current location of the person who possesses the terminal device by itself, and when the center station receives the information emitted from the terminal device, it allows for showing the location of the person carrying the terminal device, which device is designed for obtaining the current location by correcting the positioning data by an output of the magnetic sensor contained inside while receiving GPS signals from GPS satellite together with a center station which receives at least the information of the current location emitted from the terminal device which shows the current location of the terminal device and informs the relevant institution thereof.

### BACKGROUND OF THE INVENTION

1. Field of the Invention

The present Invention relates to the informing system, which consists in informing the movable bodies like public transportation or taxies from institutions like police, fire extinguishing service, rescue or welfare institutions or hospitals via center stations of the current location of the person possessing the terminal device by its manipulation.

2. Description of the Prior Art

In general, it is necessary to inform the above said institutions of the current location upon detecting the whereabouts of the roaming aged people or in case of accidents or incidents, fire or calamities other than when calling taxies.

Thus, it is possible to locate the present location by using mobile phones which are currently used as terminal devices and setting the GPS sensor inside these mobile phones and by calculating the current location of those who possess the terminal device after receiving GPS signals from the GPS satellites by GPS sensor.

However, it is true that the use of GPS signal is effective when detecting the location of vehicles and others which move rapidly but presents problems in positioning itself, whereas waves from GPS satellites are barred in places like buildings or inside the tunnels or underground centers.

### SUMMARY OF THE INVENTION

The main purpose of the present invention is to provide for an informing system to inform the service institutions of the exact current places where the person who possesses the terminal device stays upon detecting the same places and showing the said places as soon as the center station receives the information emitted from the terminal devices.

Another object of the present invention is to provide an informing system which is capable of giving precise information to the service institution after the location of the person carrying the device is accurately detected, by setting the relevant device (institution) on the movable bodies like public transportation or taxies from police, fire extinguishing service, safety, social welfare or hospitals.

Another object of the present invention is to provide an informing system, which is capable of detecting more accurately the present location by setting the gait detective sensor inside the terminal device, in order to correct the current location, thus correcting the positioning data from the GPS signal by combination of the directional data as an output of the magnetic sensor and the data corresponding to the number of walking steps as an output of the gait detective sensor.

One of other purposes of the present invention is to provide an informing system capable of selecting a plurality of the relevant institutions by setting a mode, allowing for a plurality of modes (operational modes) on one terminal device by implementing a plurality of mode measures so that the terminal device selects the service institution.

Furthermore, another object of the present invention is to provide an informing system capable of using one terminal device specifically according to its use, namely, a locking mode and unlocking mode, thus, the terminal device is provided with a locking device which prevents the constant emission of the information signal when it is locked and operates constant emission of the information signals when it is unlocked, reducing the consumed electricity or making the battery smaller so that the information signal is always emitted whenever the device is unlocked, allowing for a possible detection of the objects such as roaming aged people.

Further, another purpose of the present invention is to provide an informing system capable of informing a center station or the service institutions of the demand contents by voice signals as the terminal device is provided with the function of a mobile telephone, which enables not only communication of information signals but also connection in function of the telephone.

Other purposes of the present invention are to be clarified according the below examples.

### BRIEF DESCRIPTION OF THE DRAWING

FIG. 1 Flow diagram showing the informing system of the present invention

FIG. 2 Control circuit block diagram of the terminal device

FIG. 3 Perspective breakdown view of the magnetic sensor

FIG. 4 Explanatory diagram of the directional detection by the magnetic sensor

FIG. 5 Control circuit block diagram of the center department

FIG. 6 Explanatory diagram showing one example of the indications by the indicator.

FIG. 7 Control circuit block diagram of the car loaded devices

FIG. 8 Flowchart showing the process on the side of the terminal devices

FIG. 9 Flowchart showing the process on the side of the center department

FIG. 10 Flow diagram showing other examples of the informing system of the present invention

FIG. 11 Flowchart showing the process on the side of the center department

FIG. 12 Flow diagram showing other examples of the informing system of the present invention

FIG. 13 Flow diagram showing other examples of the informing system of the present invention

FIG. 14 Flowchart showing the process on the side of the terminal devices

FIG. 15 Flowchart showing the process on the side of the center department

### DESCRIPTION OF THE PREFERRED EMBODIMENT

One of the examples of the present invention is more particularly described using the below figures.

According to the figures from 1 to 9, the preferred embodiment will be below explained with examples in respect of the informing system of the present invention adapted for the distribution system of the taxi.

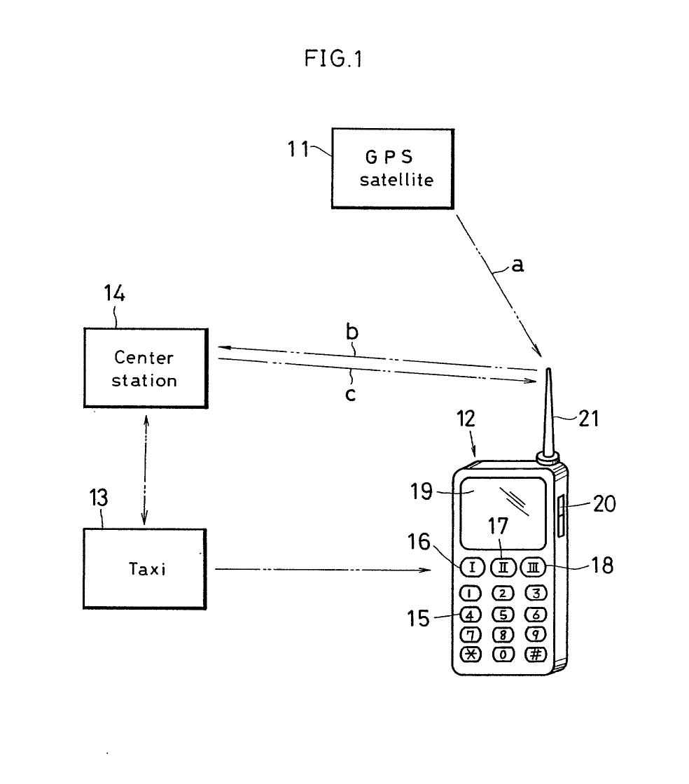

According to the FIG. 1, this car distribution system is provided with the mobile phone 12 as a terminal device to receive the GPS signal (a) from the GPS satellite 11 and the center department 14 which distributes the individual taxi 13, receiving the request signal (b) from the mobile phone 12 possessed by the client.

The mobile phone 12 has on its body main surface the number key 15 from (0) to (9) and a plurality of mode keys 16, 17 and 18 and the indication part 19 (a monitor screen) and on the other surface of the body (In this example, there is shown the body profile, but there may be shown the bottom surface or the reverse surface.), there is provided a locking switch 20 as a locking measure, which prevents constant emission of the request signal (b) when it is locked, and emits the request signal (b) constantly when it is unlocked, together with an antenna 21 which is protruding over the upper part of the body and capable of containing.

Mode keys 16, 17 and 18 are designed to select the service institutions while the mode key 16 selects the police organization including the police safety institution and the mode key 17 selects fire extinguishing service, rescue organization or hospitals and the mode key 18 selects movable bodies like taxies or vehicles.

When any of mode keys 16, 17 and 18 is turned on, after the locking switch 20 is unlocked, information signals informing the current location concerning the person who possesses the device which information has been detected by the inner device of the mobile phone 12 together with the mobile phone number as an example of the identification code already registered to the center station 14 is to be automatically sent to the center station 14 which is relevant, as a request signal b, wherein the center station 14 will send back the necessary items to the mobile phone 12 as a corresponding signal C.

In this stage, the locking switch 20 will be effective when preventing erroneous operation (or information without foundation) by the person who possesses the device.

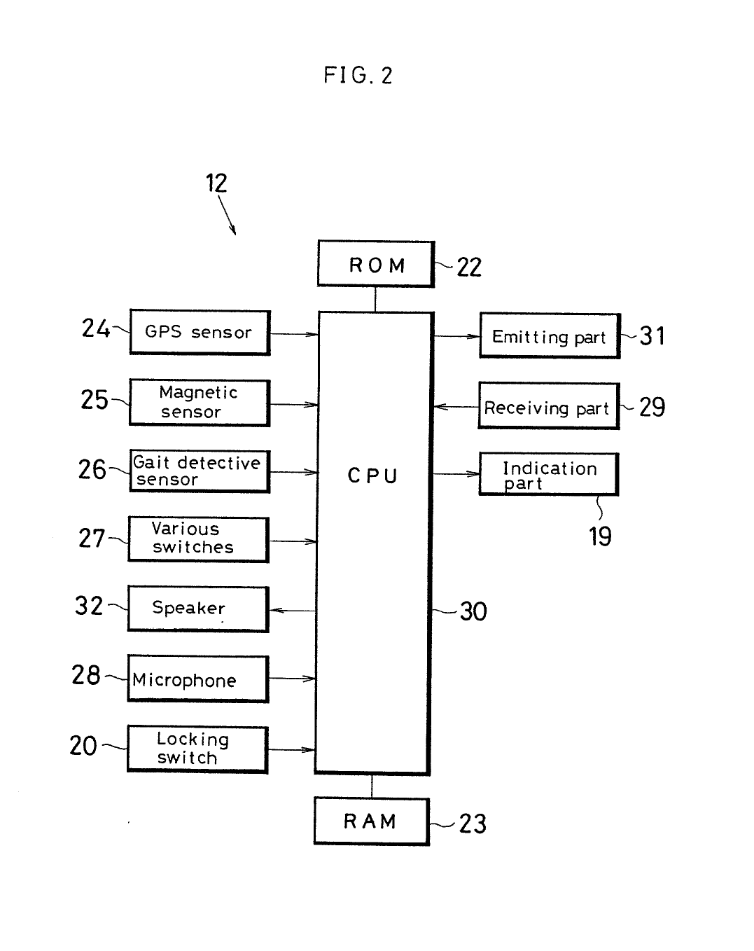

The inner parts of the said mobile phone 12 are constructed as shown in the FIG. 2.

In other words, the mobile phone 12 is provided with CPU 30 as a control measure together with ROM 22 containing programs and RAM 23 recording data, wherein CPU 30 drives and controls the emission part 31, the indication part 19 and the speaker 32 as a receiving part on the basis of the input of signals from GPS sensor 24, the magnetic sensor 25, and the gait detective sensor 26, various types of switches 27 (comprising keys 15, 16, 17 and 18 altogether as is shown in the FIG. 1), the microphone 28 as a voice sending part, locking switch 20 and receiving part 29 in compliance with the program contained in ROM 22.

The emission part 31 and the receiving part 29 are connected with an antenna 21.

Furthermore, CPU 30 is designed to position the present location on the basis of the output of the GPS sensor 24 while correcting the positioning data from the output of the magnetic sensor 25 and that of the gait detective sensor 26.

The magnetic sensor 25 may be an earth magnetic sensor of such a type that the core is rolled by the rolling wire. However, in this example, a flux gait sensor is used as is shown in the breakdown perspective diagram with the purpose of improving the detective preciseness and super-miniaturization of the sensor.

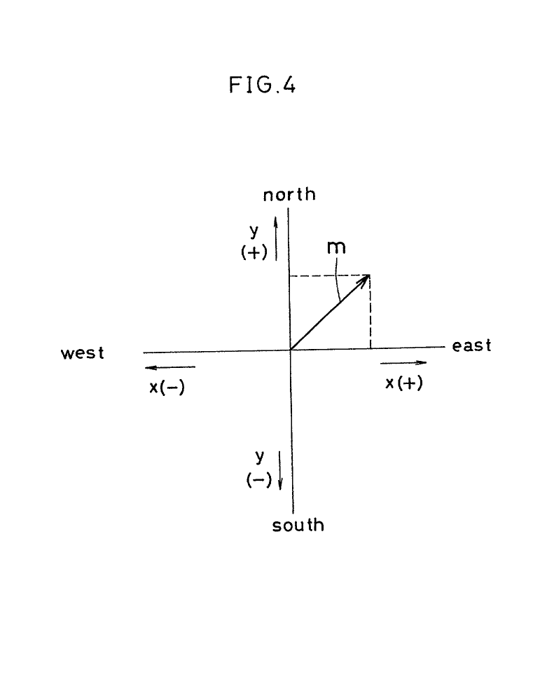

This flux gait sensor is provided with the amorphous metal core 84 and the magnetized coils 35 and 86 to be placed on the upper and down side and is also provided with a detective coil 37 to detect the direction of the x(+) as is shown in the FIG. 4 and a detective coil 38 to detect the direction of the y(+) and a detective coil 39 to detect the direction of the x (−) and a detective coil 40 to detect the direction of the y (−), wherein each coil of those 37 to 40 comprises print on the base plate and etching steps.

When magnetized coils 35 and 36 are electrically printed, the inner part of the core 34 will have magnetic lines. On the other hand, an earth magnet passes through the inner side of the core 34 in a given direction, so there arises a change in the magnetic flux by power of the magnetic lines in such a manner that each detective coil of 37-40 will have electricity. For instance, the direction can be detected as is shown in the FIG. 4 with an arrow sign (→) m.

When the amorphous metal is used for the core 34, it will react strongly against the earth magnet as the direct current magnetic field and it will act so weakly against other direct current magnetic field, which may cause error in the detection that an error might be smaller and as each coil of 35-40 is constructed on the print base, it is possible to attain the miniaturization of the magnetic sensor 25 itself (for instance, approximately 7 mm of the side and 1.00 mm or less of the thickness.)

On the other hand, as a gait detective sensor 26, a sensor of acceleration, a shake detective sensor or a vibration sensor are used to measure the volume of exercise corresponding to the steps or gaits of the person who possesses the gait detective sensor 26. (In this example, the acceleration sensor is used.)

In this way, the positioning data by GPS signals combined with the directional data as an output of the magnetic sensor 25 and the number of steps in function of an output of the gait detective sensor 26 for correction, the current position is designed to be assumed or detected.

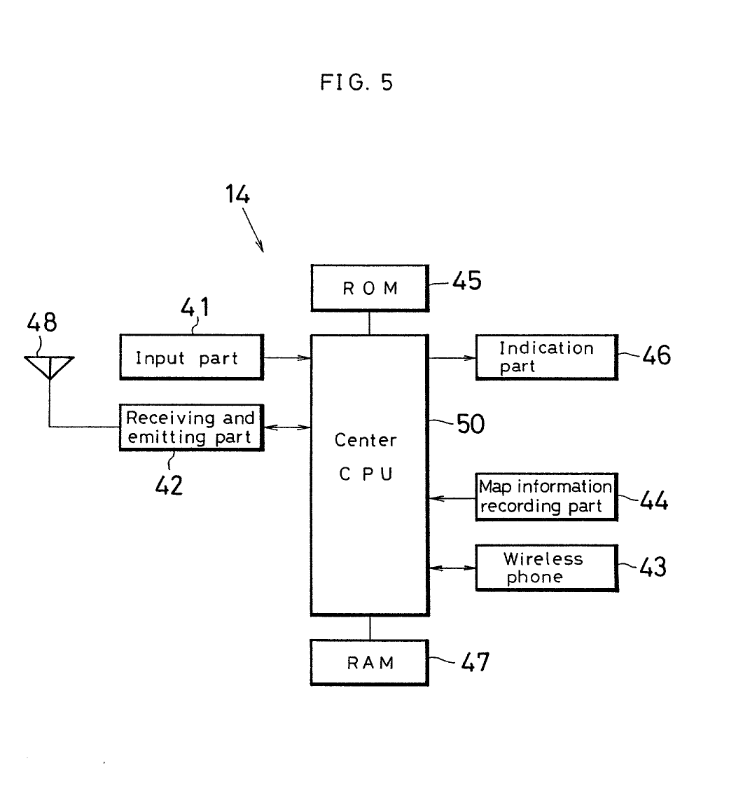

On the other hand, the center department 14 as shown in the FIG. 1 is constructed as shown in the FIG. 5.

In other words, the center department 14 possesses the CPU 50 as a control measure, CPU 50 follows the program contained in the ROM 45 and drives and controls the indication part 46 and the receiving part 42 on the basis of the input 41 consisting of various types of switches or operational keys and the receiving and sending part 42 and the wireless phone 43 which also functions as a telephone and the output signals from the map information recorder 44 of CD-ROMs, wherein RAM 47 records the recorded identification code (a recorded mobile phone number.) or other necessary data.

To the sending and receiving part 42 is connected the antenna 48, receiving the request signal b and sending the corresponding signal c as shown in the FIG. 1.

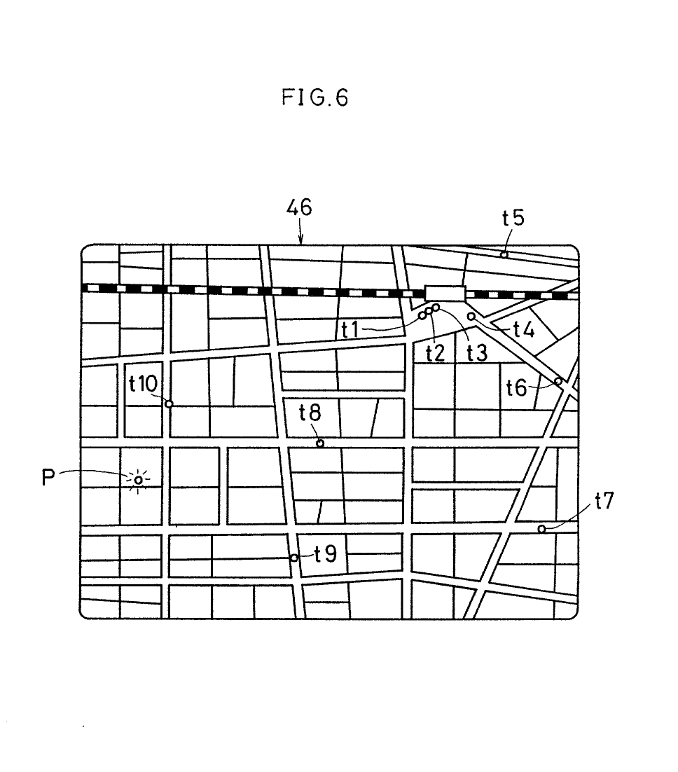

The indication part 46 shows the map on the screen in the limits of the determined area as shown in the FIG. 6, and when the request signal b is received, it is shown visibly on the above said map in the form of lighting or flickering while indicating the current location P of the relevant terminal device. Together with the indication of the present location P, the name and address of the person who possesses the device may be shown in the determined area of the indication part 46.

Here, it is possible to enlarge the map (enlargement of the nearby area of the current location P) or to reduce the size of the map (indication of the broad area on the map) and move it up and down or right and left by manipulation of the input part 41.

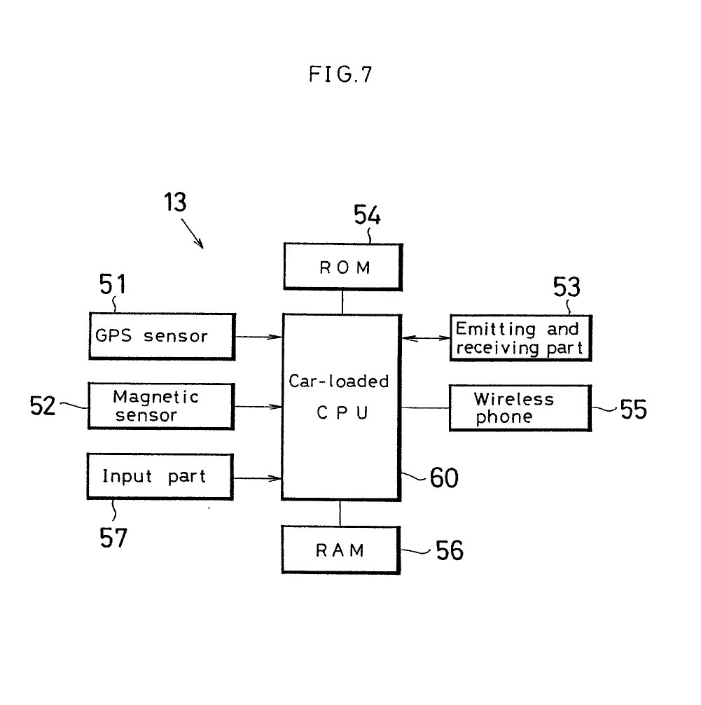

Each taxi 13 is provided with each circuit device (car-loading device) as is shown in the FIG. 7.

In other words, a car-loading device of the taxi 13 has CPU 60, which drives and controls the sending and receiving part 53 and wireless phone 55 in compliance with the program contained in the ROM 54, on the basis of the input from GPS sensor 51, a magnetic sensor 52 (constructed in the same manner as the magnetic sensor 25 in the FIG. 52), the sending and receiving part 53 or input part 57, wherein RAM 56 records the necessary data. In addition, the above mentioned magnetic sensor 52 can be omitted.

The input part 57 is a switching input for a driver to check if the taxi 13 is vacant, carrying passengers, going to pick up someone or waiting for someone so that the situational data recorded in CPU 60 is to be sent to the center department 14 together with the data concerning the current location of the taxi 13 and the identification code of the taxi 13.

The taxi 13 will run to the current place of the person who has the device upon receiving the call from the wireless phone 43 from the center department 14 or the car-loaded wireless phone 55. In the FIG. 7, however, the antenna is not shown.

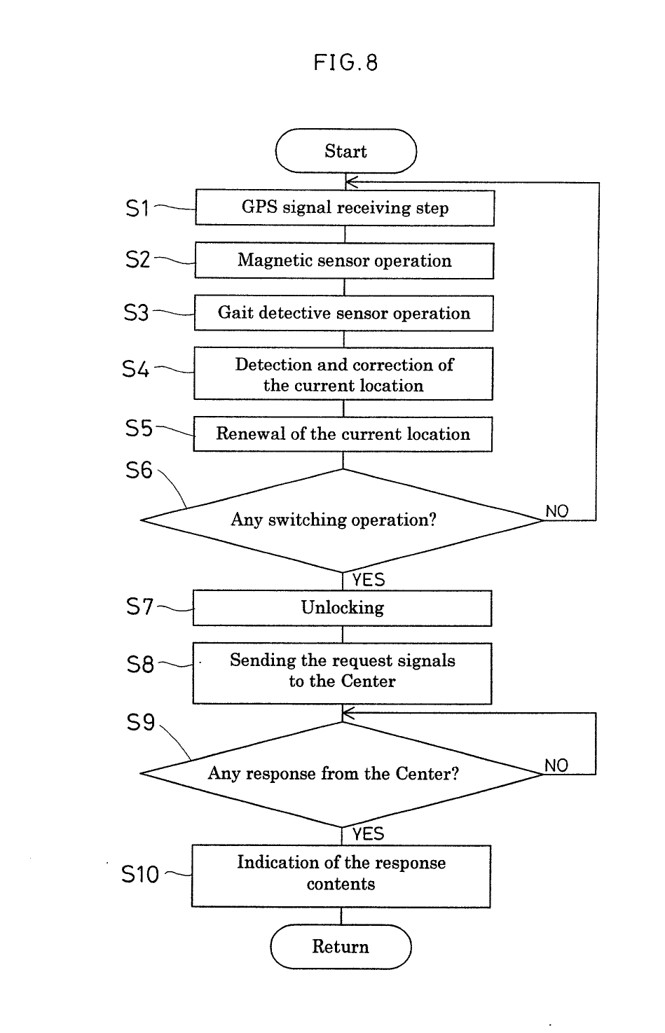

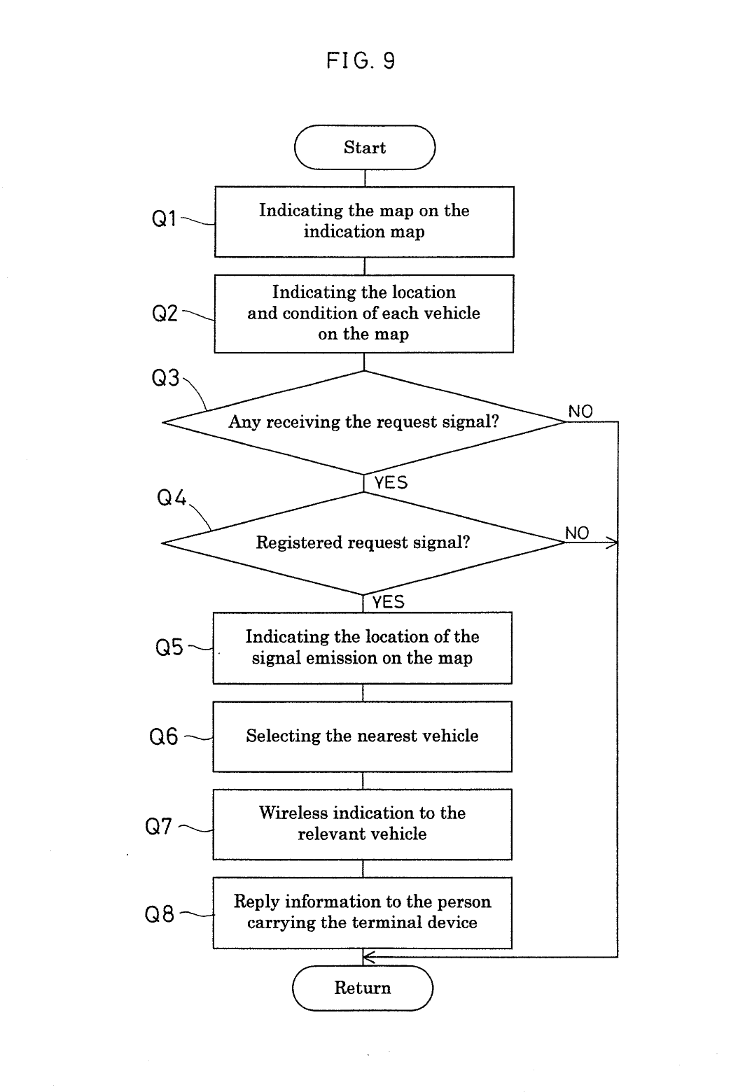

The effects of the distribution system (informing system) will be clarified below in reference to the flowchart shown in the FIG. 8 and FIG. 9.

First, in reference to the flowchart (flowchart which is turned on.), the steps of mobile phone 12 will be explained below.

In the step S1, CPU 30 (See the FIG. 2.) receives the GPS signals from the GPS satellite 11 through the antenna 21 and GPS sensor 24 and consecutively in the step S2, CPU 30 operates the magnetic sensor 25 and in the step S3, CPU 30 operates the gait detective sensor 26.

In the step S4, CPU 30 assumes, detects and corrects the positioning data from GPS signals, combining the directional data as an output of the magnetic sensor 25 and the value corresponding to the steps as an output of the gait detective sensor 26 for correction. For this reason, it is possible to precisely detect the current location of the walker who possesses the mobile phone 12 walking even inside the buildings which cannot be reached by GPS signals.

In the step S5, CPU 30 renews the current location according to the gait of the person who possesses the mobile phone so that the renewed data is recorded in the determined area of the RAM 23, allowing for retrieval.

After the locking switch 20 is unlocked in the step S6, CPU 30 decides whether or not the mode key 18 has been operated and when it decides the said mode key has not been operated, the step S6 will return to the step S1 in order to continue the positioning or renewal of the current location, wherein, if CPU 30 decides the mode key 18 has been surely operated, the step S6 will move to the next step of S7 (This is when the client operates the device in order to call a taxi.).

In this step S7, CPU 30 unlocks the mode key 18 to allow for non-operation together with unlocking of the locking switch 20 (unlocking the non-input operation by CPU 30 from the mode key 18), and in the next step S8, CPU 30 emits the request signal b to the center department 14, comprising the information signal of the current location and the mobile phone number.

In other words, it is possible to effect an automatic emission of the information on the current location of the person who possesses the mobile phone by a simple key operation without pushing any phone number of the center department 14.

In the step S9 of the next stage, CPU 30 decides whether or not the receiving part 29 has received a reply signal c from the center department 14 and only when the reply signal c has been surely received, the step S9 moves to the step S10.

In this step 10, CPU 30 shows the content of the reply in letters from the center department 14 on the indication part 19, while communicating audibly the reply content of the response signal c through the speaker 32.

In addition, this mobile phone 12 has the function of an ordinary mobile phone regardless of the locking switch 20 being locked or unlocked, thus it is also possible to communicate the request contents in detail by audible signals with the center department 14 in alternate directions.

Further, according to the flowchart of the FIG. 9, the process in the center department 14 will be clarified below.

In the step Q1, CPU 50 (See the FIG. 5.) shows visibly the map covering the determined area on the indication part 46 as shown in the FIG. 6. Next in the step Q2, CPU 50 lights up the location and situation of several taxies 13 and others on the above said map. On the FIG. 6, for the sake of an explanation, the location of a plurality of taxies are shown with a white round indicating the locations from t1 to t10.

As is shown below, the situation of each taxi 13 is to be shown live according to each different indicative mode.

For instance, vacant cars are shown with a green color and when they are loaded with passengers, they will be shown with a yellow color, wherein, if they will be picking up someone, they are to be shown with a dark blue color and when they are waiting for a passenger to ride, they will be shown with a green color just like vacant cars. However, these colorings do not limit the scope of the step and when the taxi 13 stays on the same spot or waiting for passengers, they are shown with a color mark without an arrow sign or the taxi 13 may be also shown with an arrow mark or the like, indicating the running direction. The difference between the vacant car, the loaded car, the car going to pick up someone or waiting is to be effected by the data information by switching an input, that is done by a driver who operates the input part 57 as shown in the FIG. 7.

In the step Q3, CPU 50 decides whether or not the sending and receiving part 42 has received the request signal b and when it is decided the request signal b has not been received, the step Q3 will return and when the request signal b has been surely received, it will move to the step Q4.

In this step Q4, CPU 50 decides whether or not the mobile phone number is the one pre-recorded which corresponds to the recorded code in the request signal b and when that is not the pre-recorded number the step Q4 will return and when the number is surely the one pre-recorded the step Q4 will move to the step Q5. In the meantime, instead of using the mobile phone number to check the register, another identification code may be used. On the other hand, the step of Q4 itself may be omitted.

In the step Q5, CPU 50 shows visibly the location of the signal emission of the request signal b or the present location P (See the FIG. 6.) of the person possessing the mobile phone on the map of the indication part 46 in an indication (for example, red or flickering signal) which is different from the way of indication of each taxi 13. Then, the present location or the mobile phone number of the person who possesses the mobile phone may also be indicated in the determined area of the indication part 46.

In the step Q6, a vacant car, which is nearest from the current location P of the person possessing the mobile phone, which location is shown on the map, may be selected.

In the step Q7, the center station 14 is to be operated to inform a vacant car (See the taxi 13.) which is selected, to pick up a person by a wireless phone 43 and in the next step Q7, the center department 14 is to be operated to carry out the reply emission to the person possessing the mobile phone by sending a reply signal c. to that person.

In this way, an informing system as in the examples 1-9 (distribution system of the taxies) receives the GPS signal a from the GPS satellite 11, and while correcting the positioning data by an output of the magnetic sensor 25 contained therein, provided with a center station 14 which receives at least the information of the current location (See the request signal b.) emitted from the mobile phone 12 and shows the current location P (See the FIG. 6.) of the mobile phone 12 and also informs the relevant institution (In this case, the taxi 13) thereof , and also with a mobile phone for obtaining the current location.

According to the above construction, the positioning data calculated from the GPS signal a is corrected by the output of the magnetic sensor 25, allowing for the precise detection of the present location of the person possessing the mobile phone.

In addition, when the center department 14 has received the information emitted from the mobile phone 12 as a terminal device (at least as to the information of the current location), it is possible to indicate the location of the person possessing the mobile phone, and inform the relevant institution (See the paragraph concerning the nearest vacant car.).

Furthermore, the gait detective sensor 26 is contained in the above said terminal device (See the mobile phone 12.), to correct the present location so that it is possible to correct the positioning data by GPS signal a, combining the directional data as an output of the magnetic sensor 25 and the value (data) corresponding to the number of steps as an output of the gait detective sensor 26 for correction, thus allowing for the more precise detection of the current location.

Furthermore, as a terminal device (See the mobile phone 12.) is provided with a plurality of mode measures (See the mode keys 16, 17 and 18.) selecting the relevant institutions, one terminal device (See the mobile phone 12.) can have a plurality of modes (Active modes.), which allow for the selection of a plurality of the relevant institutions by the setting of the mode.

In addition, the terminal device (See the mobile phone 12.) is provided with a locking measure (See the locking switch 20.) which measure constantly emits the information signal when unlocked and prevents the constant emission of the information signal when locked.

According to this construction, when a locking measure is locked (See the locking switch 20.), the emission of the information signal is prohibited (in this example, that is an emission to call a taxi.), thus allowing for a miniaturization of the battery or reduction of the electricity consumed and, when a measure is unlocked, the information signal is constantly emitted, thus allowing for searching roaming aged people (The concrete examples are to be later explained.), while one terminal device can be used specifically according to a locking mode and unlocking mode.

In addition, as the terminal device is provided with a mobile phone function, it is possible not only to emit information signals but also to make a call by a telephone function, thus allowing for informing the center department 14 or relevant institutions of the request content in detail and it is possible to use a mobile phone number as an identification code without having to form a identification code specifically.

In this way, when the above said system is applied to the distribution system of taxies, it is possible to distribute fast the nearest vacant cars to the customers, so that it is possible to improve the efficiency in the distribution of the cars and reduce the waiting time for the passengers.

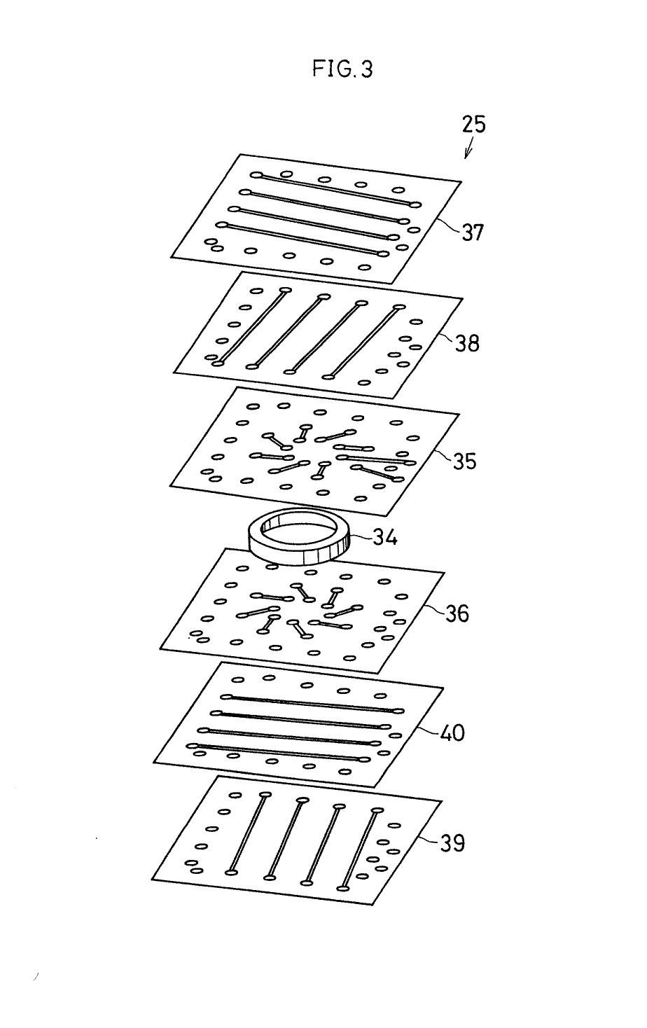

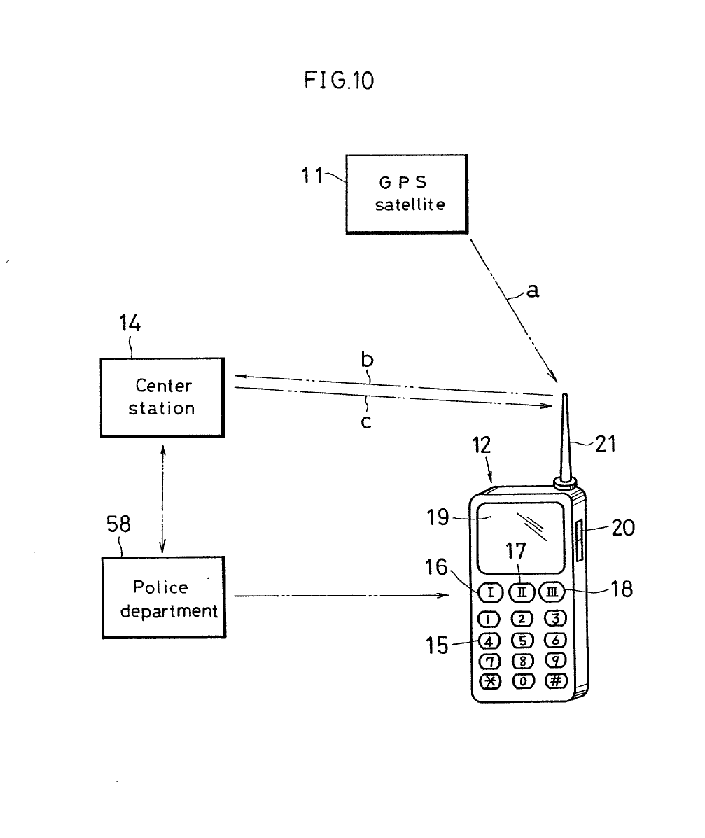

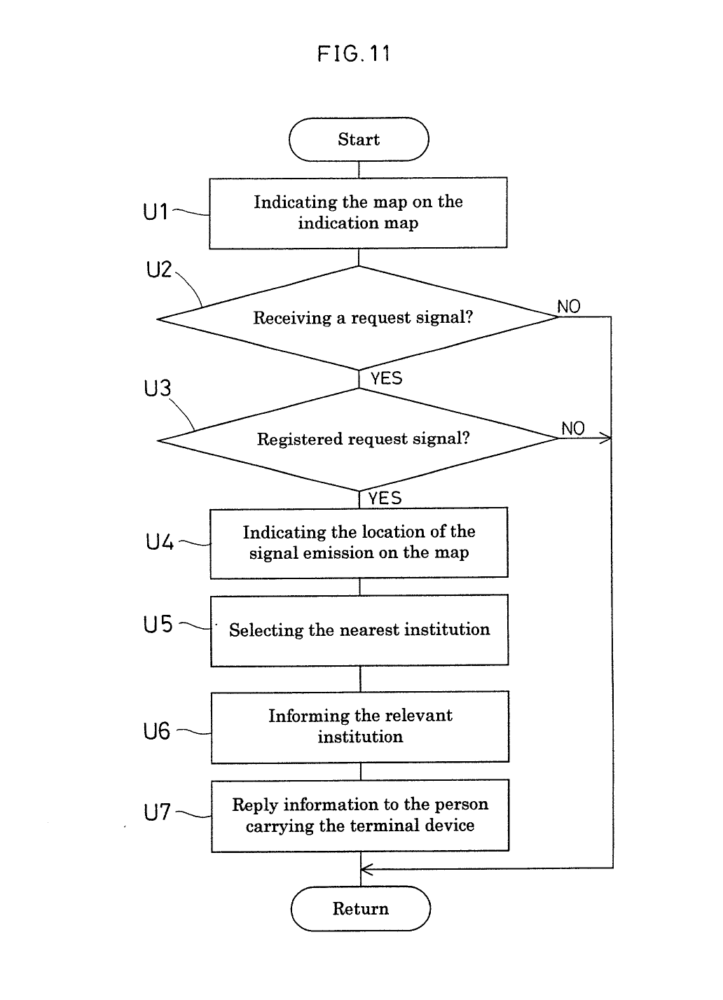

In the FIGS. 10 and 11, there are shown other examples of another informing system (an informing system in an urgent case), and according to this example, when the mode key 16 is operated, an informing step is effected to the police department through the center station 14, wherein, as for the hard structure and soft structure of the FIGS. 2, 3, 4, 5 and 8, the steps are the same as in the previous examples so that the process on the side of the center station 14 will be clarified below according to the flowchart shown in the FIG. 1.

In the step U1, CPU 50 (See the FIG. 5.) shows visibly the map of the determined area on the indication part 46.

In the following step U2, the CPU decides whether or not the sending and receiving part 42 has received the request signal b and when it is decided the request signal b has not been received, the step U2 will return, wherein, if it is decided the request signal b has been surely received, it will move to the step U3.

In this step U3, CPU 50 will decide whether the mobile phone number corresponding to the registered code inside the request signal b is the pre-recorded number or not and when it is decided that is not the pre-recorded number, the step U3 will return and when it is decided that is the pre-recorded number, it will move to the next step U4. To add, this step U3 itself may be omitted.

In the step U4, CPU 60 shows visibly the current location P of the signal emission of the request signal b or the person carrying the mobile phone on the map of the indication part 46. In this case, the current place name of the person possessing the mobile phone or the mobile phone number may be shown together at the same time in the determined area of the indication part 46.

In the next step U5, the nearest police department from the present location P of the person carrying the mobile phone on the map will be selected.

In the next step U6, the operator of the center station 14 gives information to the selected police station through the wireless phone 43 or wire-phone circuit and in the following step U7 the ope-rator of the center station 14 makes out a reply information to the person carrying the mobile phone by an emission of the response signal c.

It may be a safety assurance organization instead of the police department. When setting up the center station 14 inside the police organization, the construction may be given in such a way that there is shown a plurality of patrol cars on the map of the indication part 46, thus making the patrol cars or police motorcycles head toward the place for transaction upon receiving the request signal b and those cars and motorcycles should be the nearest ones from the present location of the person possessing the mobile phone.

Even with the above structure, the mobile phone 12 as a terminal device combines the output of the magnetic sensor 25 and the output of the gait detective sensor 26 to correct the positioning data calculated from the GPS signal (a) in order to precisely detect the current location of the person carrying the mobile phone, wherein the center station 14, upon receiving at least the information of the current location given when the mode key 16 of the mobile phone 12 is operated, show the location of the person carrying the mobile phone, providing the information to the nearest police department (including patrol cars or motorcycles for patrol).

Then, as for other points, the preferred embodiment is roughly the same as in the previous examples, 80 that more detailed explanation will be omitted except for the same signs on the same parts in the FIG. 10 as in the previous figures.

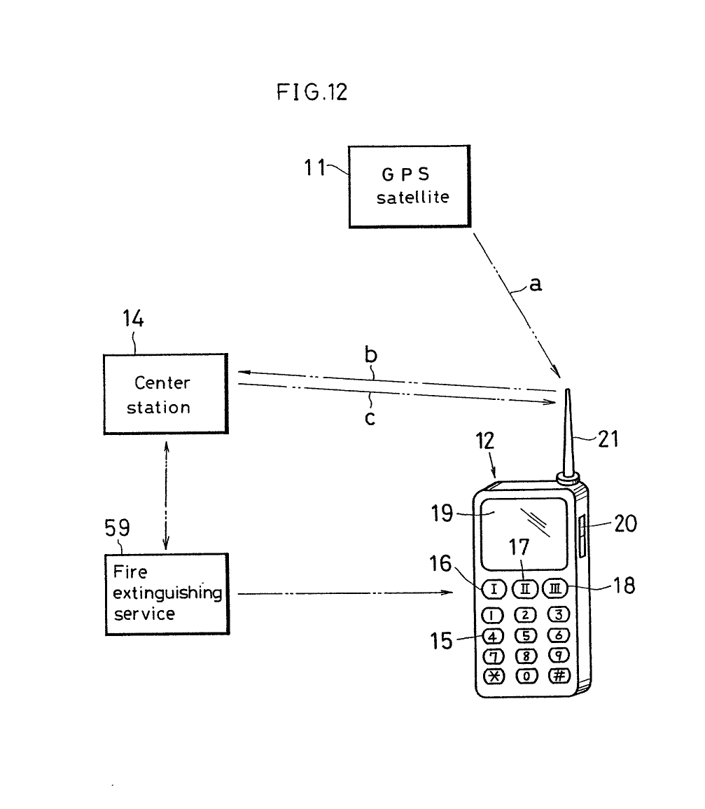

The FIG. 12 shows another more example of the informing system (an informing system in emergency.) and according to this example, when the mode key 17 is operated, the information is to be emitted to the fire extinguishing service 59 or safety organization (including the rescue boats or helicopters.) or to the hospitals through the center station 14 and using the hard structure and soft structure as in the FIGS. 2, 3, 4, 5, 8, and 11, it is possible to obtain the same effects and merits as in the above paragraph, so that more detailed explanation will be omitted except for the same signs on the same parts in the FIG. 12 as in the previous figures.

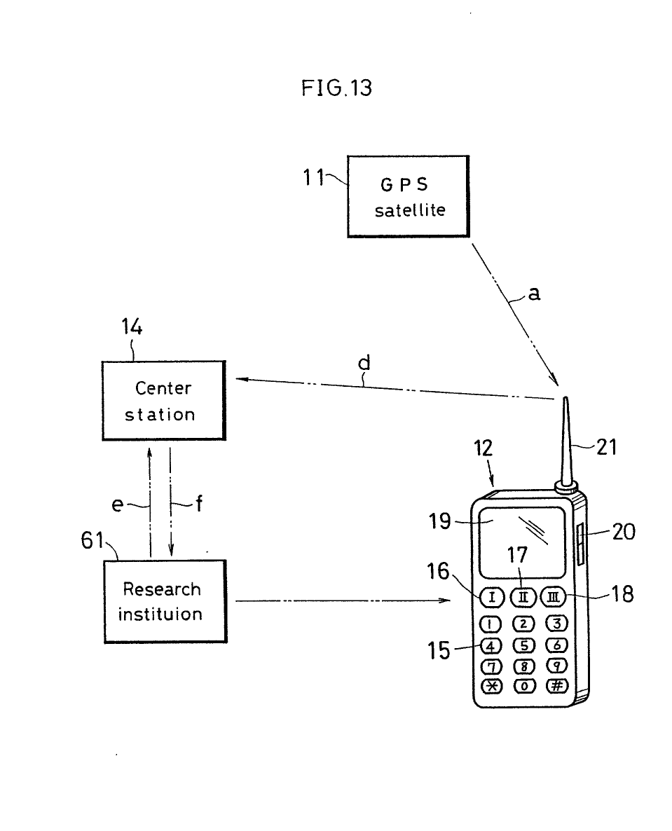

The FIGS. 13, 14 and 15 show another more example of the informing system, in which the locking switch 20 is kept unlocked, while making roaming aged people and others carry the mobile phone 12 so that the current place of the person carrying the mobile phone is to be notified to the research institution 61 or the client of the research when there is a report from the client of the research or from the research institution 61 serving as a welfare organization including welfare homes for aged people for the sake of the research. In this example also, the circuit devices as in the FIGS. 2,3,4 and 5 are to be used.

When the locking switch 20 is unlocked, the mobile phone number is to be constantly emitted as a terminal information d for an example of the identification code verifying the person possessing the mobile phone and the information concerning the current location of the person possessing the mobile phone, which is detected by the mobile phone 12.

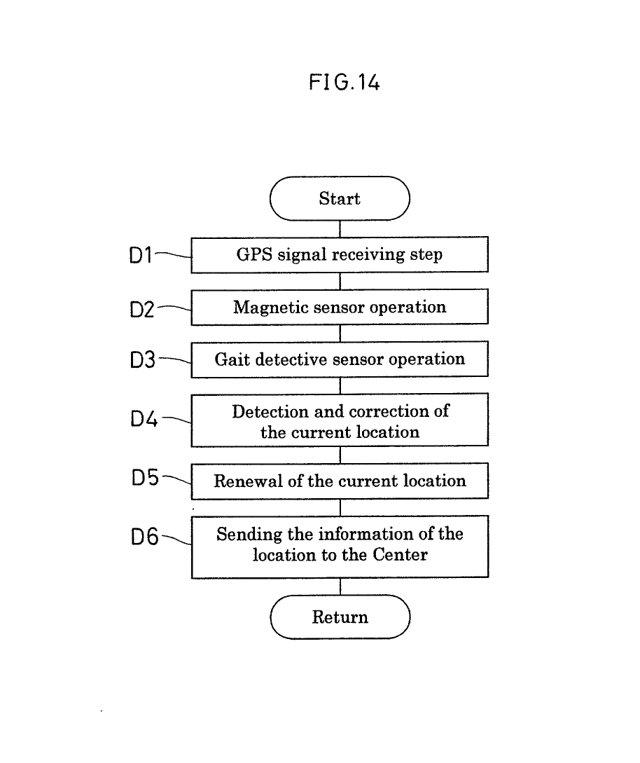

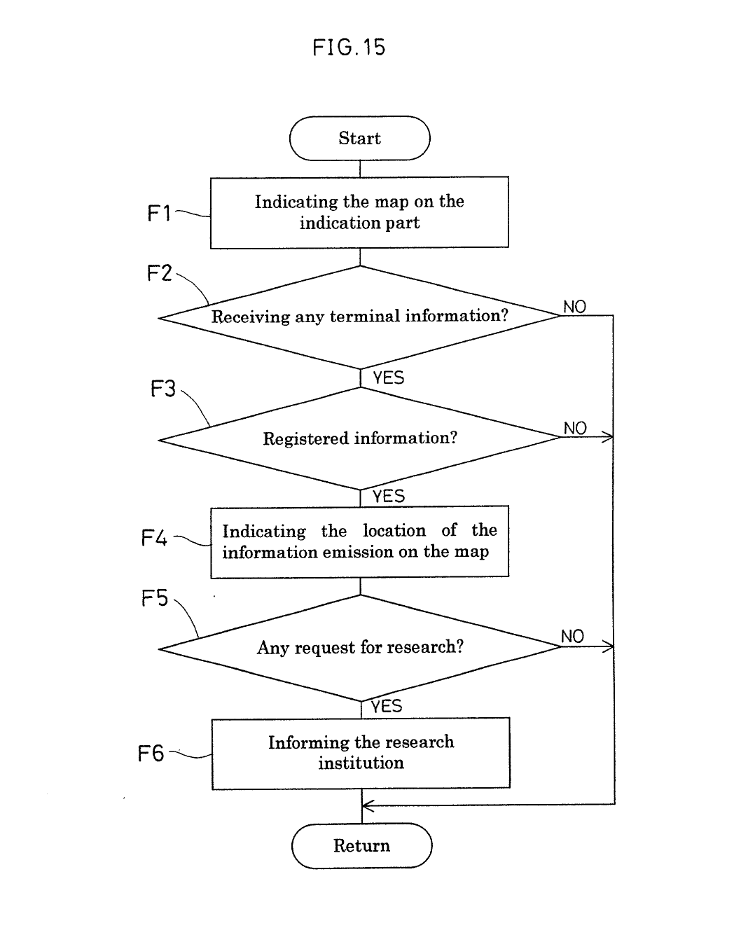

The effects of the informing system (research system for searching for the objects or people) will be particularly described below according to the flowchart of the FIGS. 14 and 15.

In reference to the flowchart in the FIG. 14 (the flowchart to be used in case of electricity being turned on), the step involving the mobile phone 12 will be explained.

In the step D1, CPU 30 (See the FIG. 2.) receives GPS signal from the GPS satellite 11 through the antenna 21 and/or GPS sensor 24 and in the step D2, CPU 30 puts in operation the magnetic sensor 25, while, in the step D3, CPU 30 puts into action the gait detective sensor 26.

In the following step D4, CPU 30 combines the directional data as an output of the magnetic sensor 25 and the value corresponding to the number of waking steps as an output of the gait detective sensor 26 to correct the positioning data from the GPS signal, allowing for the detection by assumption and correction of the present location. For this reason, it is possible to precisely detect the current location of the walker or the person carrying the mobile phone 12 even inside buildings which cannot be reached by the GPS signal.

In the following step D5, CPU 30 renews the present location of the person carrying the mobile phone according to the walking steps or gait of that person, thus recording the renewed data in the determined area of the RAM 23, available for retrieval.

In the following step D6, CPU 30 emits the information of the current location and the mobile phone number as a terminal information d through the emitting part 31 and antenna 21.

According to the step shown in the FIG. 14, the information (d) of the person carrying the mobile phone is to be sent to the center station 14.

Here, in reference to the flowchart in the FIG. 15, the process in the center station 14 will be below explained.

In the step F1, CPU 50 (See the FIG. 5.) shows visibly the map of the determined area on the indication part 46.

In the step F2, CPU 50 decides whether or not the sending and receiving part 42 has received the terminal information (d) and when it is decided the terminal information has not been received, the step F2 will return and when it is decided the terminal information has surely been received, it will move the next step F3.

In this step F3, CPU 50 decides whether the mobile phone number corresponding to the recorded code inside the terminal information (d) is the pre-recorded number or not and when it is not, the step F3 will return and when it is the pre-recorded number, it will move to the next step F4. Here, instead of checking the registration by the mobile phone number, another identification code may be used. To add, the step F3 itself may be omitted.

In the step F4, CPU 50 shows visibly the location of the signal emission concerning the terminal information (d) or the current location of the person carrying the mobile phone on the map of the indication part 46. In this case, the name of the person carrying the mobile phone or the name of the current place or the mobile phone number may also be shown in the determined area of the indication part 46.

In the next step F5, CPU 50 decides whether or not the sending and receiving part 42 has received the research request signal (e) from the research institution 61 or the client of the research and when it is decided the research request signal has not been received, the step F5 will return, and when it is decided the research request signal has surely been received, it will move to the next step F6.

In this step F6, the operator of the center station 14 gives a reply signal (f) concerning the current location of the research object, which is shown in the indication part 46 to the research institution 61 using the wireless phone 43 or wire telephone circuit.

Instead of using the flowchart shown in the FIG. 15, each step may be constructed in such an order of F1, F5, F2, F3, F4 and F6 to be processed.

Even with the above stated construction, the mobile phone 12 as a terminal device combines the output of the magnetic sensor 25 and the output of the gait detective sensor 26 to correct the positioning data calculated on the basis of the GPS signal (a) so that the current location of the person carrying the mobile phone can be precisely detected. In addition, when the center station 14 has received the terminal information (d) emitted from the mobile phone 12, the place of the person carrying the mobile phone will be shown and in case that there is a request for research from the research institution 61 or the research client, it is possible to inform the institution which has made a request, of a current location of the relevant research object (including a step of voice sending by voice signal.)

According to the preferred embodiment shown in the FIGS. 13 to 15, for other points, the contents are almost the same as in the previous examples, so that more detailed explanation will be omitted in the FIG. 13 except for the same signs for the same parts as in the previous figures.

In connection with the structure of the present invention and examples, the terminal device of the present invention corresponds to the mobile phone 12 as a mobile terminal of the examples and in the same manner, the service institution corresponds to a taxi 13, police institution 58, fire extinguishing service 59 or research institutions, wherein the mode measures correspond to the mode keys 16, 17 and 18 and the locking measure corresponds to the locking switch 20, however, the scope of the present invention will not be limited to the construction of the preferred embodiment mentioned above.

For example, in each of the above mentioned example, the request signal (b) and the terminal information (d) are so constructed that they are to be sent to the center station 14 without using the GPS satellite, however the signal (b) and information (d) may be so constructed that they are to be sent to the center station 14, using the GPS satellite.

Furthermore, instead of using the structure unlocking the locking switch 20 manually, the locking may be released by the inner circuit when any of the mode keys 16, 17 and 18 are kept operated for a certain number of minutes or when they are kept operated twice or more consecutively.

To summarize, according to the present invention, the terminal device detects the present location of the person carrying the mobile phone precisely and when the center station receives the information emitted from the terminal device, it has the merit that it is possible to inform the service institutions, indicating the location of the person carrying the mobile phone.

What is claimed is:

1. An informing system provided with a center station capable of informing the relevant institutions, which system receives GPS signal from the GPS satellite, having a terminal device searching for the current location by correcting the positioning data on the basis of an output of the magnetic sensor contained therein, while receiving at least the information concerning the current location emitted from the terminal device and showing the current location of the terminal device.

2. The informing system according to the claim 1, wherein the relevant institutions are a police department, fire extinguishing service, a rescue organization, welfare organization and hospitals or taxies and other movable bodies.

3. The informing system according to the claim 1, wherein a gait detective sensor is contained inside the terminal device to correct the present location.

4. The informing system according to the claim 1, wherein the terminal device is provided with a plurality of mode measures to select the relevant institutions.

5. The informing system according to the claim 1, wherein the terminal device prohibits the constant emission of the information signal when it is locked, and has a locking measure capable of emitting the information signal constantly when it is unlocked.

6. The informing system according to the claim 1, wherein the terminal device is provided with a function of a mobile phone.
